(19) United States
(12) Patent Application Publication
(10) Pub. No.: US 2026/0340210 A1
(43) Pub. Date: Oct. 29, 2026

(54) INTEGRATED CIRCUIT DESIGN METHOD AND SYSTEM

(71) Applicant: TAIWAN SEMICONDUCTOR MANUFACTURING COMPANY, LTD., Hsinchu (TW)

(72) Inventors: Chi-Wen CHANG, Hsinchu (TW); Wan-Ru LIN, Hsinchu (TW)

(21) Appl. No.: 19/188,365

(22) Filed: Apr. 24, 2025

(51) Int. Cl. G06F 30/12; G06F 30/392; G06F 30/394

(52) U.S. Cl. CPC G06F 30/12; G06F 30/392; G06F 30/394

(57) ABSTRACT

A method of manufacturing an integrated circuit (IC) includes generating an IC layout diagram, and generating the IC layout diagram includes communicating a procedure call from an electronic design automation (EDA) program to an application programming interface (API), in response to the procedure call, executing a corresponding API procedure, thereby transferring IC layout design criteria to the EDA program, based on the transferred IC layout design criteria, modifying, using the EDA program, the IC layout diagram, and storing, using the EDA program, the modified IC layout diagram in a storage device.

### BACKGROUND

The ongoing trend in miniaturizing integrated circuits (ICs) has resulted in progressively smaller devices which consume less power, yet provide more functionality at higher speeds than earlier technologies. Miniaturization has been achieved through design and manufacturing innovations tied to increasingly strict specifications. Various electronic design automation (EDA) tools are used to generate, revise, and verify designs for semiconductor devices while ensuring that design and manufacturing specifications are met.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a flowchart of a method of manufacturing an IC based on an IC layout diagram, in accordance with some embodiments.

FIG. 2 depicts a system and corresponding IC design flow, in accordance with some embodiments.

FIG. 3 depicts a system and corresponding IC design flow, in accordance with some embodiments.

FIG. 4 depicts a system and corresponding IC design flow, in accordance with some embodiments.

FIG. 5 depicts a system and corresponding IC design flow, in accordance with some embodiments.

FIG. 6 depicts a system and corresponding IC design flow, in accordance with some embodiments.

FIG. 7 depicts a system and corresponding IC design flow, in accordance with some embodiments.

FIG. 8 depicts an application programming interface (API) suite, in accordance with some embodiments.

FIG. 9 is a block diagram of an IC design system, in accordance with some embodiments.

FIG. 10 is a block diagram of an IC manufacturing system, and an IC manufacturing flow associated therewith, in accordance with some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In various embodiments, a system and method are directed to an application programming interface (API) suite communicating bi-directionally with an electronic design automation (EDA) program such that integrated circuit (IC) layout design criteria are transferred from one or more API procedures to the EDA program and used to modify an IC layout diagram. In various embodiments, an API procedure transfers a given IC layout design item either by directly communicating the item to the EDA program or by storing the item an IC design database from which it is retrieved by the EDA program.

IC layout diagrams used to control the manufacturing processes by which corresponding IC devices are constructed are thereby capable of being generated based on the transferred IC layout design criteria. By using the API suite for the IC layout design criteria transfer, proprietary and/or customized IC layout knowledge, specifications, and guidelines are integrated into the manufacturing flow more efficiently and with improved protection compared to other approaches, e.g., those that do not use an API suite for transfers of IC layout design criteria.

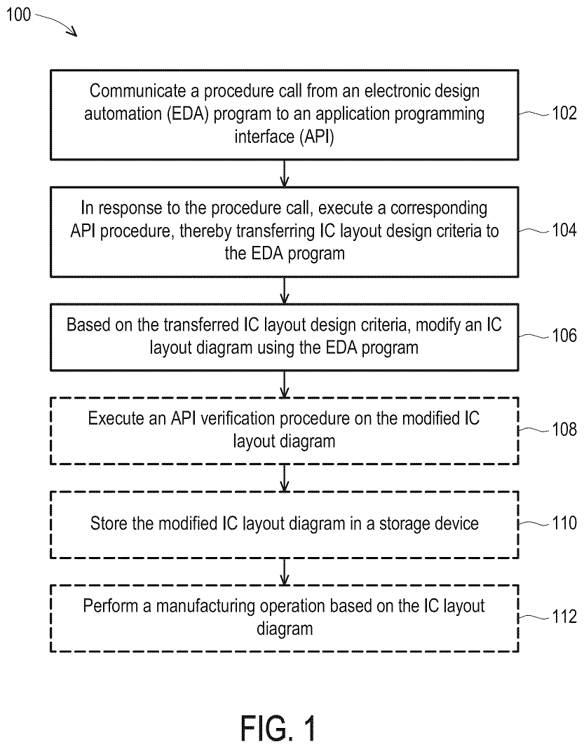

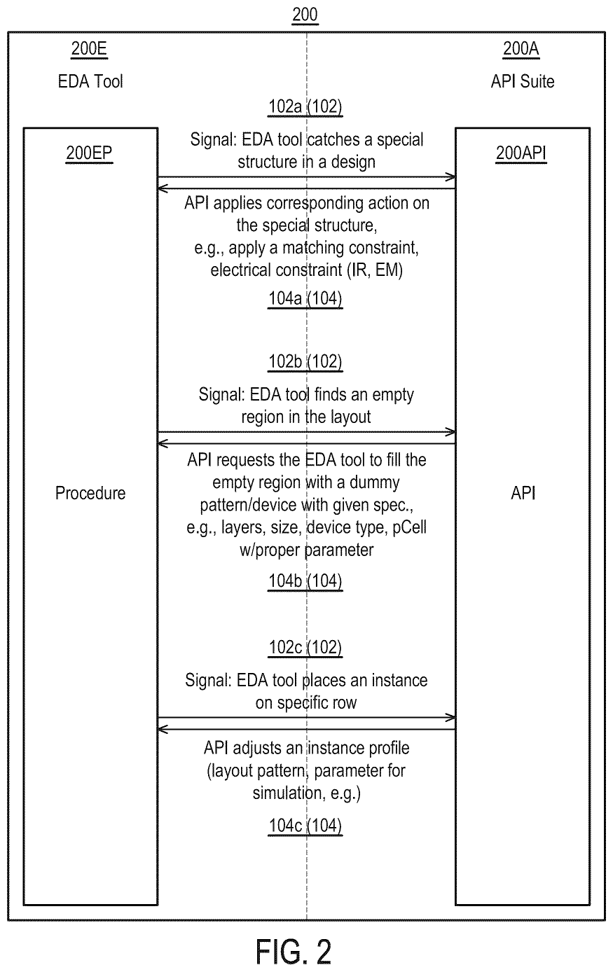

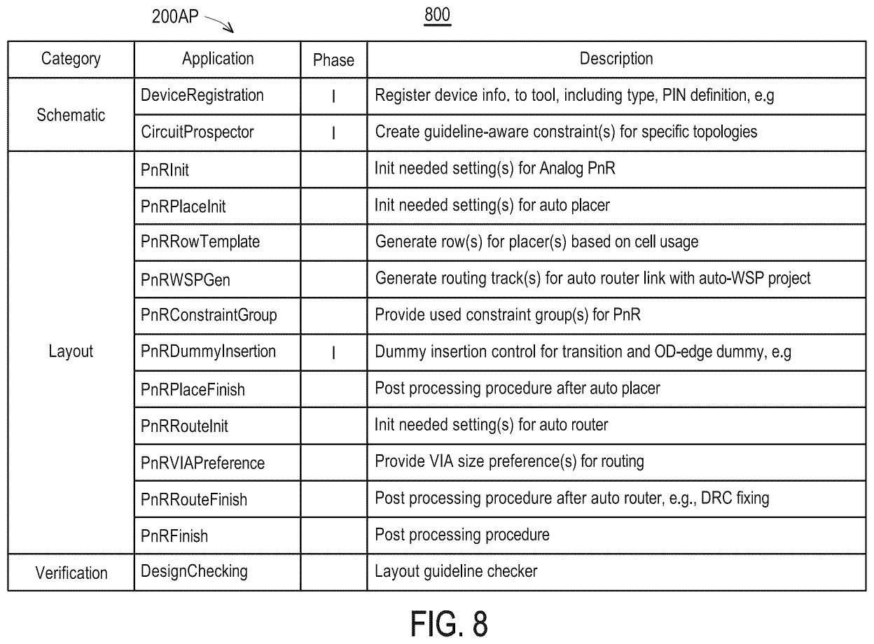

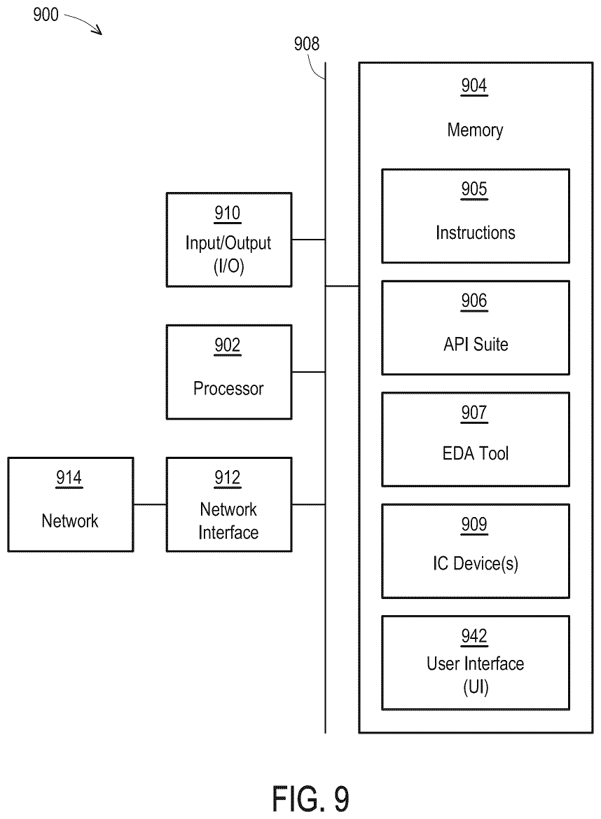

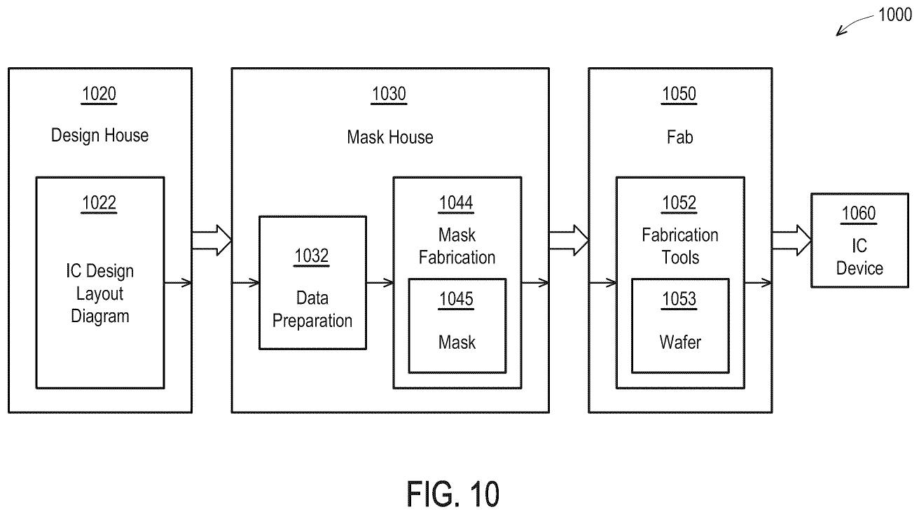

In accordance with various embodiments, as discussed below, FIG. 1 is a flowchart of a method 100 of manufacturing an IC based on an IC layout diagram, each of FIGS. 2-7 depicts a non-limiting example of a corresponding system 200 and IC design flow, FIG. 8 depicts a non-limiting example of an API suite 800, FIG. 9 is a block diagram of an IC design system 900, e.g., an EDA system 900, configured to perform some or all of the operations of method 100, and FIG. 10 is a block diagram of an IC manufacturing system and associated IC manufacturing flow 1000 by which one or more IC devices are manufactured based at least in part on method 100.

FIG. 1 is a flowchart of method 100 of manufacturing an IC based on an IC layout diagram, in accordance with some embodiments. In some embodiments, generating the IC layout diagram includes generating the IC layout diagram corresponding to an IC device manufactured based on the generated IC layout diagram.

In some embodiments, some or all of method 100 is executed by at least one processor of one or more computers, e.g., one or more instances of a processor 902 of EDA system 900, discussed below with respect to FIG. 9.

Some or all of the operations of method 100 are capable of being performed as part of a design procedure performed in a design house, e.g., a design house 1020 discussed below with respect to FIG. 10.

In some embodiments, the operations of method 100 are performed in the order depicted in FIG. 1. In some embodiments, the operations of method 100 are performed simultaneously and/or in an order other than the order depicted in FIG. 1. In some embodiments, one or more operations are performed before, between, during, and/or after performing one or more operations of method 100. In some embodiments, one or more of the operations of method 100 are repeated.

At operation 102, a procedure call is communicated from an EDA program to an API. Communicating the procedure call from an EDA program is part of executing an EDA program, also referred to as an EDA tool in some embodiments, on one or more EDA systems, e.g., one or more instances of EDA system 900 discussed below with respect to FIG. 9.

An EDA tool is one or more software programs, including hardware and/or related services in some embodiments, configured to perform a variety of functions that at least partially design, document, and verify one or more IC layout diagrams as part of an IC manufacturing flow, e.g., as discussed below with respect to FIG. 10.

In some embodiments, an EDA tool is some or all of one or more instances of EDA tool 907 discussed below with respect to FIG. 9.

In various embodiments, an EDA tool includes one or more EDA programs such as Cadence®, Synopsis®, or Mentor®. In some embodiments, EDA communications are based on one or more programming languages, e.g., SKILL, tool command language (TCL), or another language or predefined format suitable for communications between an EDA program and an API.

The API is a software interface between external programs and a suite (API suite) of software application procedures configured to perform predetermined functions that complement one or more of the functions performed by the EDA tool, as discussed below.

In some embodiments, an API suite is some or all of one or more instances of API suite 906 discussed below with respect to FIG. 9.

In some embodiments, communicating the procedure call to the API includes communicating the call to one or more of the procedures listed in API suite 800 discussed below with respect to FIG. 8.

In some embodiments, communicating the procedure call from the EDA program to the API includes communicating entirely or partially on a same system or entirely or partially between multiple systems, e.g., a single instance or multiple instances of EDA system 900 discussed below with respect to FIG. 9.

In some embodiments, communicating the procedure call from the EDA program includes triggering the procedure call in response to detecting, using the EDA program, one or more circuit features in a schematic, one or more of an empty region, a predefined structure type, placement location, or other feature in a corresponding IC layout diagram, or another predefined threshold, condition, event, or the like in the IC layout design flow.

In some embodiments, communicating the procedure call from the EDA program includes triggering the procedure call in response to starting, finishing, or reaching a predefined portion of an internal procedure of the EDA program.

In some embodiments, communicating the procedure call from the EDA program to the API includes passing one or more parameters from the EDA program to the API, e.g., design information related to the triggering event within the EDA program.

At operation 104, in response to the procedure call, a corresponding API procedure is executed, thereby transferring IC layout design criteria to the EDA program. Executing the API procedure includes receiving the procedure call at the API and matching the procedure call to the corresponding API procedure of the API suite. In some embodiments, executing the API procedure includes passing one or more parameters received as part of the EDA program procedure call from the API to the corresponding API procedure.

In various embodiments, executing the API procedure includes providing manufacturing process-specific, e.g., foundry-specific, data to the EDA program, initializing and/or altering one or more EDA program settings, providing and/or customizing one or more guidelines, constraints, thresholds, or sets of rules and/or preferences to the EDA program, performing one or more guideline and/or design rule checking functions, providing and/or modifying one or more IC layout diagram features, feature definitions, or orientations, or generating and/or modifying one or more passed parameters. Other API procedure functions that complement one or more of the functions performed by the EDA tool are within the scope of the present disclosure.

Executing the API procedure includes transferring IC layout design criteria from the API procedure to the EDA program, also referred to in some embodiments as applying the IC layout design criteria to the EDA program, using the API procedure. The IC layout design criteria include one or more items of IC layout design information related to the function performed by the API procedure.

In various embodiments, transferring the IC layout design criteria includes transferring one or more initialization settings and/or layout constraints, e.g., a performance-based constraint, a layout-dependent effect (LDE) constraint, a parasitic resistance constraint, a parasitic capacitance constraint, or a reliability-based constraint.

In some embodiments, transferring the IC layout design criteria includes transferring one or more cell placement criteria, e.g., a row height, a cell orientation, a component description format (CDF) setting, or a cell placement constraint.

In some embodiments, transferring the IC layout design criteria includes transferring one or more dummy or other feature criteria, e.g., a dummy feature specification, a master dummy cell, a CDF setting, or a guard ring feature specification.

In some embodiments, transferring the IC layout design criteria includes transferring one or more routing criteria, e.g., a routing design rule, routing track information, via size criteria, a parasitic resistance constraint, a parasitic capacitance constraint, or a reliability-based constraint.

Transferring other IC layout design criteria that complement one or more of the functions performed by the EDA tool are within the scope of the present disclosure.

In various embodiments, transferring the IC layout design criteria includes directly communicating the IC layout design criteria from the API procedure to the EDA program, or updating, using the API procedure, information in an IC design database based on the IC layout design criteria, and retrieving the updated information from the IC design database using the EDA program.

In various embodiments, the IC design database is a same database configured to store IC layout diagrams, e.g., a cell or IC layout diagram library, or separate from one or more databases or other storage devices configured to store IC layout diagrams, e.g., hosted on one or more systems such as one or more instances of EDA system 900 discussed below with respect to FIG. 9.

Non-limiting examples of IC design flow in accordance with executing API procedures and transferring IC layout design criteria are discussed below with respect to an API suite 200A and FIGS. 2-7.

At operation 106, based on the transferred IC layout design criteria, an IC layout diagram is modified using the EDA program. In various embodiments, modifying the IC layout diagram based on the transferred IC layout design criteria includes receiving the IC layout design criteria directly from the API procedure or retrieving the updated information stored in the IC design database based on the IC layout design criteria.

In some embodiments, modifying the IC layout diagram includes selecting one or more cells based on the IC layout design criteria including one or more layout constraints, e.g., a row height, cell orientation, CDF setting, cell placement constraint, cell identifier, or cell file. In some embodiments, selecting a cell includes receiving the cell included in the IC layout design criteria or retrieving the cell from a storage device, e.g., IC device(s) 909 discussed below with respect to FIG. 9.

In some embodiments, modifying the IC layout diagram includes performing one or more of a placement procedure or a routing procedure based on the IC layout design criteria including one or more layout constraints, initialization settings, and/or placement criteria.

In some embodiments, modifying the IC layout diagram includes performing a fill procedure based on the IC layout design criteria including one or more dummy feature criteria, e.g., a dummy feature specification, a master or other dummy cell, a CDF setting, or a guard ring feature specification.

In some embodiments, modifying the IC layout diagram includes performing a routing procedure based on the IC layout design criteria including one or more routing criteria, e.g., a routing design rule, routing track information, via size criteria, a parasitic resistance constraint, a parasitic capacitance constraint, or a reliability-based constraint.

Other IC layout diagram modifications that complement one or more of the functions performed by the EDA tool are within the scope of the present disclosure.

In some embodiments, modifying the IC layout diagram includes modifying the IC layout diagram based on multiple instances of transferred IC layout design criteria, e.g., based on multiple iterations of one or both of operations 102 or 104.

At operation 108, in some embodiments, an API verification procedure is executed on the modified IC layout diagram. In some embodiments, executing the API verification procedure includes performing a design rule check or a quality check on the modified IC layout diagram.

In some embodiments, one or more of operations 102, 104, or 106 are repeated based on one or more results of executing the API verification procedure.

In some embodiments, executing the API verification procedure is performed in response to the EDA tool finishing a routing, verification, storing, or other procedure.

At operation 110, in some embodiments, the modified IC layout diagram is stored in a storage device, using the EDA tool.

In some embodiments, storing the modified IC layout diagram in the storage device includes multiple instances of the EDA tool storing the modified IC layout diagram in the storage device, e.g., after each of multiple iterations of one or more of operations 102, 104, 106, or 108.

In some embodiments, storing the IC layout diagram in the storage device includes storing the IC layout diagram in a non-volatile, computer-readable memory or a database, and/or includes storing the IC layout diagram over a network. In some embodiments, storing the IC layout diagram in the storage device includes storing the IC layout diagram in IC device(s) 909 and/or over network 914 of IC layout diagram generation system 900, discussed below with respect to FIG. 9.

At operation 112, in some embodiments, one or more manufacturing operations, one or more lithographic exposures, are performed based on the IC layout diagram. Non-limiting examples of performing one or more manufacturing operations, e.g., one or more lithographic exposures, based on the IC layout diagram are discussed below with respect to FIG. 10.

By executing some or all of the operations of method 100, an API suite communicates bi-directionally with an EDA program such that integrated circuit (IC) layout design criteria are transferred from one or more API procedures to the EDA program and used to modify an IC layout diagram. The IC layout diagram, used to control the manufacturing processes by which one or more corresponding IC devices are constructed, is thereby generated based on the transferred IC layout design criteria.

By using the API suite for the IC layout design criteria transfer, proprietary and/or customized IC layout knowledge, specifications, and guidelines are integrated into the manufacturing flow more efficiently and with improved protection compared to other approaches, e.g., those that do not use an API suite for transfers of IC layout design criteria.

Each of FIGS. 2-7 depicts system 200 and a corresponding IC design flow, in accordance with some embodiments. System 200 and the corresponding design flows are non-limiting examples of an EDA system and are presented to illustrate realization of the benefits discussed above. In some embodiments, system 200 corresponds to EDA system 900 discussed below with respect to FIG. 9.

As depicted in FIGS. 2-7, system 200 includes an EDA tool 200E and an API suite 200A. EDA tool 200E includes one or more instances of an EDA procedure 200EP, and API suite 200A includes an API 200API and one or more instances of an API procedure 200AP.

The embodiment depicted in FIG. 2 includes three instances of operations 102 (e.g., 102a, 102b and 102c) and 104 (e.g., 104a, 104b and 104c) in which EDA procedure 200EP communicates with API 200API in response to predefined design criteria, and the one or more instances of API procedure 200AP (not shown for the purpose of clarity) cause IC layout design criteria to be transferred from API 200API to EDA procedure 200EP in accordance with the communications received by API 200API.

In the three instances, EDA tool 200E communicates a procedure call in operation 102 in response to detecting a predefined structure, a predefined region, and a predefined row, and a corresponding API procedure is executed in operation 104 in response to the received procedure call. For example, in instance 102a of operation 102, EDA tool 200E catches a special structure in a design, and in instance 104a of operation 104, API 200API applies corresponding action on the special structure, e.g., apply a matching constraint, electrical constraint (IR, EM). In instance 102b of operation 102, EDA tool 200E finds an empty region in the layout, and in instance 104a of operation 104, API 200API requests the EDA tool to fill the empty region with a dummy pattern/device with given a specification, e.g., layers, size, device type, or a parameterized cell (pCell) with a proper parameter. In instance 102c of operation 102, EDA tool 200E places an instance, e.g., of a cell, on a specific row, and in instance 104c of operation 104, API 200API adjusts an instance profile, e.g., a layout pattern or parameter for simulation.

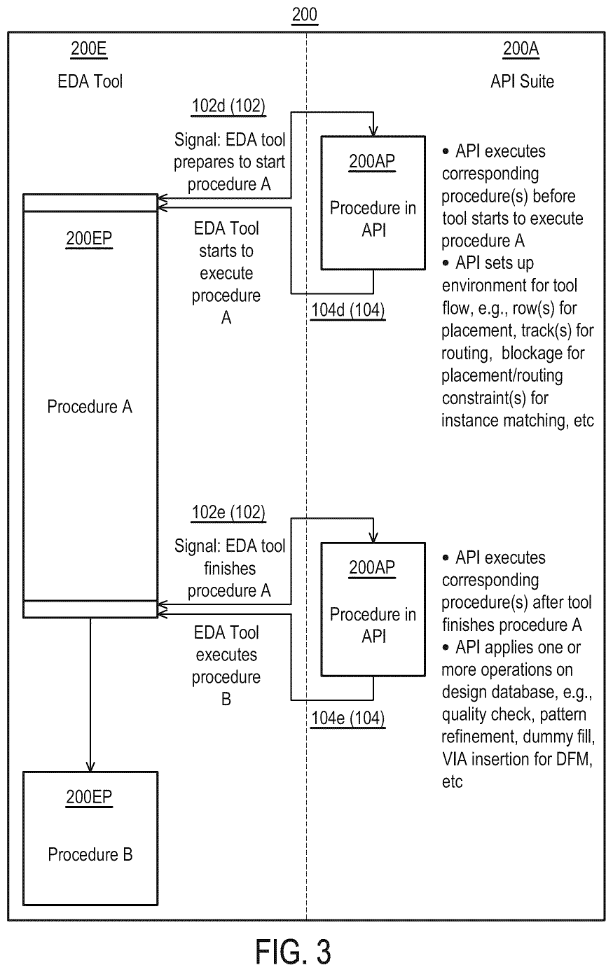

The embodiment depicted in FIG. 3 includes two instances of operations 102 (e.g., 102d and 102e) and 104 (e.g., 104d and 104e) in which EDA tool 200E communicates with a first instance of API procedure 200AP in a first instance 102d of operation 102 prior to the start of an instance of EDA procedure 200EP, Procedure A, and communicates with a second instance of API procedure 200AP in a second instance 102e of operation 102 after the finish of the instance of Procedure A. In this example, the first instance of API procedure 200AP executes a corresponding first instance 104d of operation 104 which sets up an environment for EDA tool flow by transferring IC layout design criteria 200DC (not shown) including, e.g., row(s) for placement, track(s) for routing, blockage for placement/routing constraint(s) for instance matching, to EDA tool 200E. The second instance of API procedure 200AP executes a corresponding second instance 104e of operation 104 which applies one or more operations on a design database, e.g., a quality check, pattern refinement, dummy fill, or VIA insertion for DFM.

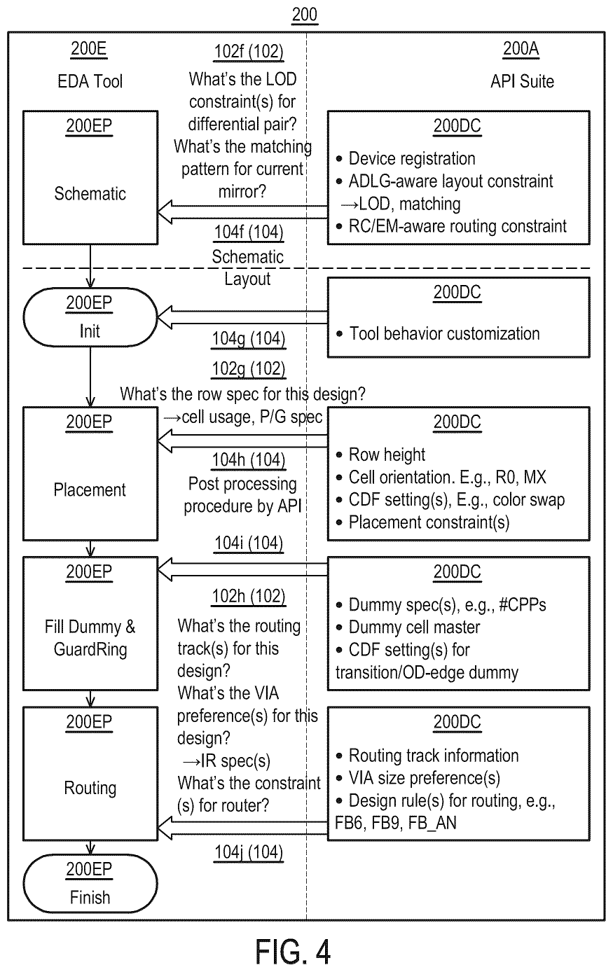

The embodiment depicted in FIG. 4 includes three instances of operation 102 (e.g., 102f, 102g, and 102h), five instances of operation 104 (e.g., 104f, 104g, 104h, 104i, and 104j), and instances of EDA procedure 200EP corresponding to specific EDA tool design functions, and corresponding instances of API procedure 200AP (not shown) transfer IC layout design criteria 200DC accordingly.

For example, in the first instance 102f of operation 102, EDA tool 200E, based on one or more predefined schematic elements, requests IC layout design information, e.g., long oxide definition (LOD), also referred to as long active region in some embodiments, constraint(s) or matching patterns for a current mirror, and in the first instance 104f of operation 104, an instance of API procedure 200AP transfers IC layout design criteria 200DC including, e.g., device registration, corresponding analog device layout guideline (ADLG) aware layout constraint(s), LOD constraint(s), matching pattern(s), or RC/EM-aware routing constraint(s). In the second instance 104g of operation 104, an instance of API procedure 200AP transfers IC layout design criteria 200DC including tool behavior customization information corresponding to an EDA initialization procedure. In the second instance 102g of operation 102, EDA tool 200E communicates a procedure call requesting placement specifications such as a row, cell usage, or power group (P/G) specification, e.g., as passed parameters, and, in the third instance 104h of operation 104, an instance of API procedure 200AP transfers IC layout design criteria 200DC including corresponding placement specifications such as row height or cell orientation information, CDF setting(s), or placement constraint(s), e.g., as passed parameter values.

In the fourth instance 104i of operation 104, an instance of API procedure 200AP transfers IC layout design criteria 200DC including dummy cell information, e.g., dummy specification(s) such as a contact poly pitch (CPP) number, a dummy cell master, or CDF setting(s), corresponding to an EDA fill procedure. In the third instance 102h of operation 102, EDA tool 200E communicates a procedure call corresponding to routing specifications such as routing track(s), VIA preference(s), IR specification(s), or router constraint(s), e.g., as passed parameters, and, in the fifth instance 104j of operation 104, an instance of API procedure 200AP transfers IC layout design criteria 200DC including the corresponding routing specifications, e.g., as passed parameter values.

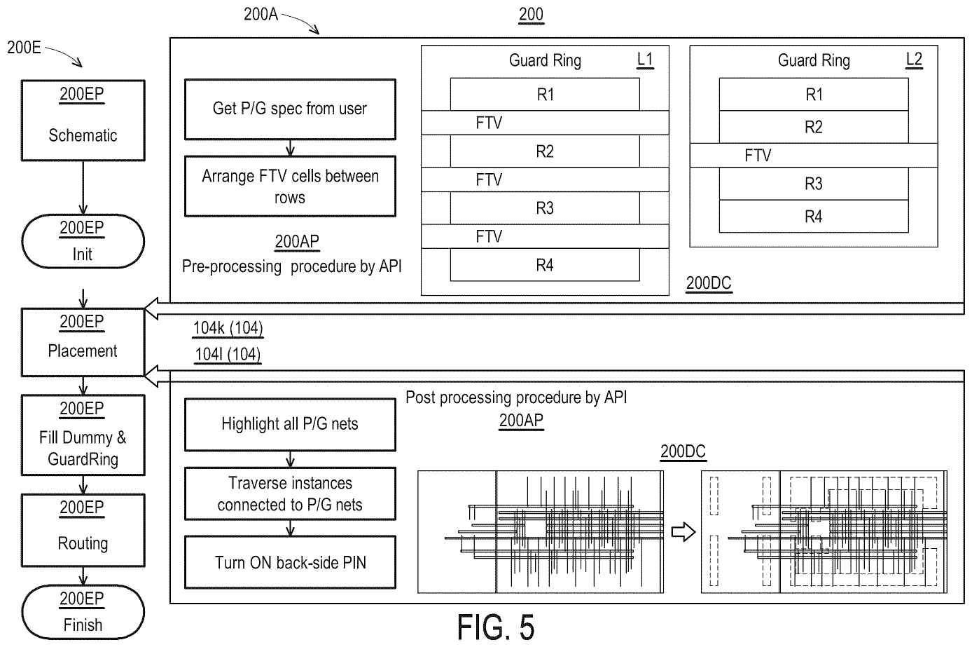

The embodiment depicted in FIG. 5 includes two instances of operation 104 (e.g., 104k and 104i) and instances of EDA procedure 200EP corresponding to specific EDA tool design functions including a placement procedure. In this example, in the first instance 104k of operation 104, a first instance of API procedure 200AP is executed to transfer IC layout design criteria 200DC including feedthrough via (FTV) placement information relative to rows R1-R4 corresponding to one of layouts L1 or L2 before the start of the placement procedure based on P/G specifications. In the second instance 104l of operation 104, a second instance of API procedure 200AP is executed after completion of the placement procedure to transfer IC layout design criteria 200DC including P/G net highlighting and back-side device access pin (PIN) activation information configured to modify design flow based on the P/G specifications.

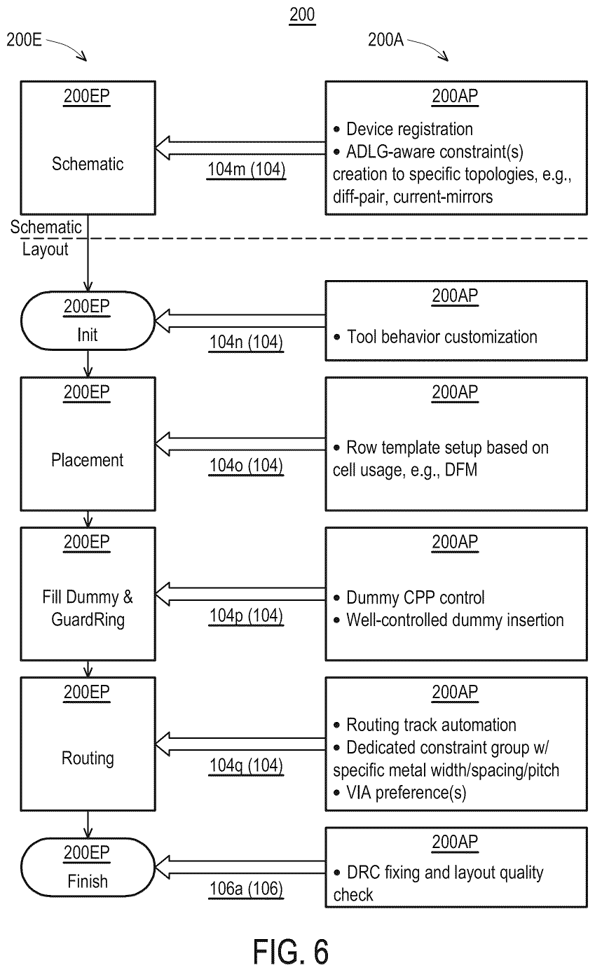

The embodiment depicted in FIG. 6 includes five instances of operation 104 (e.g., 104m, 104n, 104o, 104p, and 104q), one instance 106a of operation 106, and instances of EDA procedure 200EP corresponding to specific EDA tool design functions. In this example, in the first instance 104m of operation 104, a first instance of API procedure transfers device registration and ADLG-aware constraint information to a schematic instance of EDA procedure 200EP. In the second instance 104n of operation 104, a second instance of API procedure 200AP transfers IC layout design criteria 200DC including tool behavior customization information to an initialization instance of EDA procedure 200EP. In the third instance 104o of operation 104, a third instance of API procedure 200AP transfers IC layout design criteria 200DC including row template setup information to a placement instance of EDA procedure 200EP. In the fourth instance 104p of operation 104, a fourth instance of API procedure 200AP transfers IC layout design criteria 200DC including dummy CPP control and/or insertion information to a fill instance of EDA procedure 200EP. In the fifth instance 104q of operation 104, a fifth instance of API procedure 200AP transfers IC layout design criteria 200DC including routing track automation, constraint group, and/or VIA preference information to a routing instance of EDA procedure 200EP.

In the instance 106a of operation 106, a sixth instance of API procedure 200AP executes a design rule check (DRC) and/or layout quality check and, in some embodiments, performs one or more IC layout design modifications in response to detecting one or more errors.

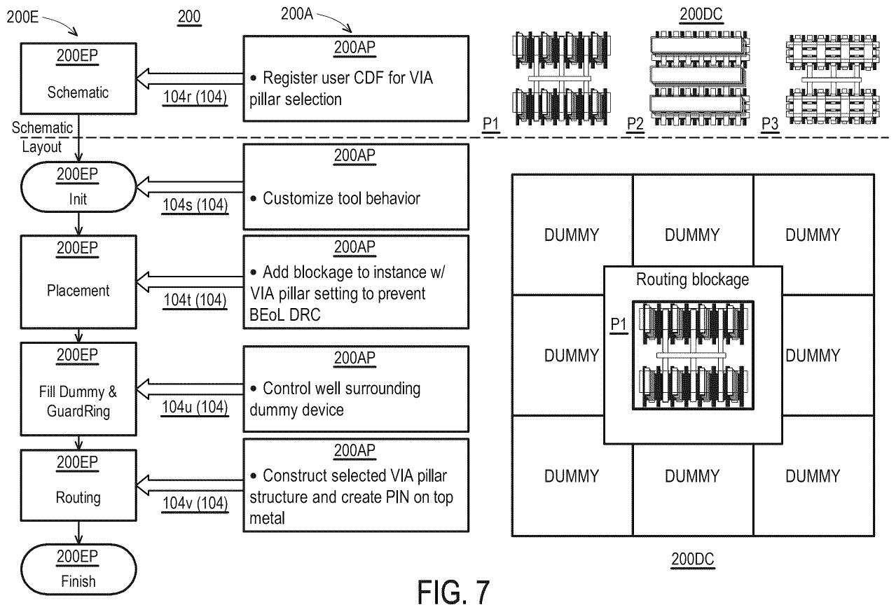

The embodiment depicted in FIG. 7 includes five instances of operation 104 (e.g., 104r, 104s, 104t, 104u, and 104v) and instances of EDA procedure 200EP corresponding to specific EDA tool design functions. Corresponding instances of API procedure 200AP are executed in accordance with a CDF corresponding to construction of a via pillar and positioning of a PIN on a top metal layer of an IC device.

For example, in the first instance 104r of operation 104, a first instance of API procedure 200AP transfers IC layout design criteria 200DC including a selection of one of three pillar types P1, P2, or P3 based on the CDF. In the second instance 104s of operation 104, a second instance of API procedure 200AP transfers IC layout design criteria 200DC including tool behavior customization information to an initialization instance of EDA procedure 200EP. In the third instance 104t of operation 104, a third instance of API procedure 200AP transfers IC layout design criteria 200DC including blockage information to a placement instance of EDA procedure 200EP. In the fourth instance 104u of operation 104, a fourth instance of API procedure 200AP transfers IC layout design criteria 200DC including dummy device well control information to a fill instance of EDA procedure 200EP. In the fifth instance 104v of operation 104, a fifth instance of API procedure 200AP transfers IC layout design criteria 200DC including via pillar structure and top metal PIN information to a routing instance of EDA procedure 200EP.

FIG. 8 depicts API suite 800, in accordance with some embodiments. API suite 800 is a non-limiting example of API suite 200A and includes two schematic-level instances of API procedure 200AP directed to IC layout design criteria including definitions and guidelines, eleven layout-level instances of API procedure 200AP directed to PnR functions, and a verification instance of API procedure 200AP.

FIG. 9 is a block diagram of an electronic design automation (EDA) system 900 in accordance with some embodiments. Methods described herein of designing IC layout diagrams, in accordance with one or more embodiments, are implementable using EDA system 900, in accordance with some embodiments.

In some embodiments, EDA system 900 is one or more instances of a general purpose computing device, each instance including a hardware processor 902 and a non-transitory, computer-readable storage medium 904. Storage medium 904, amongst other things, is encoded with, i.e., stores, computer program code 905, also referred to as instructions 905 in some embodiments, and some or all of API suite 906 and/or EDA tool 907, i.e., one or more sets of executable instructions. Execution of instructions 905, API suite 906, and/or EDA tool 907 by hardware processor 902 represents (at least in part) an EDA system which implements a portion or all of the methods described herein in accordance with one or more embodiments (hereinafter, the noted processes and/or methods).

Processor 902 is electrically coupled to computer-readable storage medium 904 via a bus 908. Processor 902 is also electrically coupled to an I/O interface 910 by bus 908. A network interface 912 is also electrically connected to processor 902 via bus 908. Network interface 912 is connected to a network 914, so that processor 902 and computer-readable storage medium 904 are capable of connecting to external elements via network 914. Processor 902 is configured to execute computer program code 905 encoded in computer-readable storage medium 904 in order to cause system 900 to be usable for performing a portion or all of the noted processes and/or methods. In one or more embodiments, processor 902 is a central processing unit (CPU), a multi-processor, a distributed processing system, an application specific integrated circuit (ASIC), and/or a suitable processing unit.

In one or more embodiments, computer-readable storage medium 904 is an electronic, magnetic, optical, electromagnetic, infrared, and/or a semiconductor system (or apparatus or device). For example, computer-readable storage medium 904 includes a semiconductor or solid-state memory, a magnetic tape, a removable computer diskette, a random access memory (RAM), a read-only memory (ROM), a rigid magnetic disk, and/or an optical disk. In one or more embodiments using optical disks, computer-readable storage medium 904 includes a compact disk-read only memory (CD-ROM), a compact disk-read/write (CD-R/W), and/or a digital video disc (DVD).

In one or more embodiments, storage medium 904 stores computer program code 906 configured to cause system 900 (where such execution represents (at least in part) the EDA system) to be usable for performing a portion or all of the noted processes and/or methods. In one or more embodiments, storage medium 904 also stores information which facilitates performing a portion or all of the noted processes and/or methods. In one or more embodiments, storage medium 904 stores IC device(s) 909 including IC layout diagrams and/or cells as disclosed herein.

EDA system 900 includes I/O interface 910. I/O interface 910 is coupled to external circuitry. In one or more embodiments, I/O interface 910 includes a keyboard, keypad, mouse, trackball, trackpad, touchscreen, and/or cursor direction keys for communicating information and commands to processor 902.

EDA system 900 also includes network interface 912 coupled to processor 902. Network interface 912 allows system 900 to communicate with network 914, to which one or more other computer systems are connected. Network interface 912 includes wireless network interfaces such as BLUETOOTH, WIFI, WIMAX, GPRS, or WCDMA; or wired network interfaces such as ETHERNET, USB, or IEEE-1364. In one or more embodiments, a portion or all of noted processes and/or methods, is implemented in two or more systems 900.

System 900 is configured to receive information through I/O interface 910. The information received through I/O interface 910 includes one or more of instructions, data, design rules, libraries of standard cells, and/or other parameters for processing by processor 902. The information is transferred to processor 902 via bus 908. EDA system 900 is configured to receive information related to a user interface (UI) through I/O interface 910. The information is stored in computer-readable medium 904 as UI 942.

In some embodiments, a portion or all of the noted processes and/or methods is implemented as a standalone software application for execution by a processor. In some embodiments, a portion or all of the noted processes and/or methods is implemented as a software application that is a part of an additional software application. In some embodiments, a portion or all of the noted processes and/or methods is implemented as a plug-in to a software application. In some embodiments, at least one of the noted processes and/or methods is implemented as a software application that is a portion of an EDA tool. In some embodiments, a portion or all of the noted processes and/or methods is implemented as a software application that is used by EDA system 900.

In some embodiments, the processes are realized as functions of a program stored in a non-transitory computer readable recording medium. Examples of a non-transitory computer readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

FIG. 10 is a block diagram of an integrated circuit (IC) manufacturing system 1000, and an IC manufacturing flow associated therewith, in accordance with some embodiments. In some embodiments, based on a layout diagram, at least one of (A) one or more semiconductor masks or (B) at least one component in a layer of a semiconductor integrated circuit is fabricated using manufacturing system 1000.

In FIG. 10, IC manufacturing system 1000 includes entities, such as a design house 1020, a mask house 1030, and an IC manufacturer/fabricator (fab) 1050, that interact with one another in the design, development, and manufacturing cycles and/or services related to manufacturing an IC device 1060. The entities in system 1000 are connected by a communications network. In some embodiments, the communications network is a single network. In some embodiments, the communications network is a variety of different networks, such as an intranet and the Internet. The communications network includes wired and/or wireless communication channels. Each entity interacts with one or more of the other entities and provides services to and/or receives services from one or more of the other entities. In some embodiments, two or more of design house 1020, mask house 1030, and IC fab 1050 is owned by a single larger company. In some embodiments, two or more of design house 1020, mask house 1030, and IC fab 1050 coexist in a common facility and use common resources.

Design house (or design team) 1020 generates an IC design layout diagram 1022, e.g., including one or more IC layout diagrams as discussed above with respect to FIGS. 1-9. IC design layout diagram 1022 includes various geometrical patterns designed for an IC device 1060. The geometrical patterns correspond to patterns of metal, oxide, or semiconductor layers that make up the various components of IC device 1060 to be fabricated. The various layers combine to form various IC features. For example, a portion of IC design layout diagram 1022 includes various IC features, such as an active region, gate electrode, source and drain, metal lines or vias of an interlayer interconnection, and openings for bonding pads, to be formed in a semiconductor substrate (such as a silicon wafer) and various material layers disposed on the semiconductor substrate. Design house 1020 implements a proper design procedure to form IC design layout diagram 1022. The design procedure includes one or more of logic design, physical design or place and route. IC design layout diagram 1022 is presented in one or more data files having information of the geometrical patterns. For example, IC design layout diagram 1022 can be expressed in a GDSII file format or DFII file format.

Mask house 1030 includes data preparation 1032 and mask fabrication 1044. Mask house 1030 uses IC design layout diagram 1022 to manufacture one or more masks 1045 to be used for fabricating the various layers of IC device 1060 according to IC design layout diagram 1022. Mask house 1030 performs mask data preparation 1032, where IC design layout diagram 1022 is translated into a representative data file (RDF). Mask data preparation 1032 provides the RDF to mask fabrication 1044. Mask fabrication 1044 includes a mask writer. A mask writer converts the RDF to an image on a substrate, such as a mask (reticle) 1045 or a semiconductor wafer 1053. The design layout diagram 1022 is manipulated by mask data preparation 1032 to comply with particular characteristics of the mask writer and/or requirements of IC fab 1050. In FIG. 10, mask data preparation 1032 and mask fabrication 1044 are illustrated as separate elements. In some embodiments, mask data preparation 1032 and mask fabrication 1044 can be collectively referred to as mask data preparation.

In some embodiments, mask data preparation 1032 includes optical proximity correction (OPC) which uses lithography enhancement techniques to compensate for image errors, such as those that can arise from diffraction, interference, other process effects and the like. OPC adjusts IC design layout diagram 1022. In some embodiments, mask data preparation 1032 includes further resolution enhancement techniques (RET), such as off-axis illumination, sub-resolution assist features, phase-shifting masks, other suitable techniques, and the like or combinations thereof. In some embodiments, inverse lithography technology (ILT) is also used, which treats OPC as an inverse imaging problem.

In some embodiments, mask data preparation 1032 includes a mask rule checker (MRC) that checks the IC design layout diagram 1022 that has undergone processes in OPC with a set of mask creation rules which contain certain geometric and/or connectivity restrictions to ensure sufficient margins, to account for variability in semiconductor manufacturing processes, and the like. In some embodiments, the MRC modifies the IC design layout diagram 1022 to compensate for photolithographic implementation effects during mask fabrication 1044, which may undo part of the modifications performed by OPC in order to meet mask creation rules.

In some embodiments, mask data preparation 1032 includes lithography process checking (LPC) that simulates processing that will be implemented by IC fab 1050 to fabricate IC device 1060. LPC simulates this processing based on IC design layout diagram 1022 to create a simulated manufactured device, such as IC device 1060. The processing parameters in LPC simulation can include parameters associated with various processes of the IC manufacturing cycle, parameters associated with tools used for manufacturing the IC, and/or other aspects of the manufacturing process. LPC takes into account various factors, such as aerial image contrast, depth of focus (DOF), mask error enhancement factor (MEEF), other suitable factors, and the like or combinations thereof. In some embodiments, after a simulated manufactured device has been created by LPC, if the simulated device is not close enough in shape to satisfy design rules, OPC and/or MRC are be repeated to further refine IC design layout diagram 1022.

It should be understood that the above description of mask data preparation 1032 has been simplified for the purposes of clarity. In some embodiments, data preparation 1032 includes additional features such as a logic operation (LOP) to modify the IC design layout diagram 1022 according to manufacturing rules. Additionally, the processes applied to IC design layout diagram 1022 during data preparation 1032 may be executed in a variety of different orders.

After mask data preparation 1032 and during mask fabrication 1044, a mask 1045 or a group of masks 1045 are fabricated based on the modified IC design layout diagram 1022. In some embodiments, mask fabrication 1044 includes performing one or more lithographic exposures based on IC design layout diagram 1022. In some embodiments, an electron-beam (e-beam) or a mechanism of multiple e-beams is used to form a pattern on a mask (photomask or reticle) 1045 based on the modified IC design layout diagram 1022. Mask 1045 can be formed in various technologies. In some embodiments, mask 1045 is formed using binary technology. In some embodiments, a mask pattern includes opaque regions and transparent regions. A radiation beam, such as an ultraviolet (UV) beam, used to expose the image sensitive material layer (e.g., photoresist) which has been coated on a wafer, is blocked by the opaque region and transmits through the transparent regions. In one example, a binary mask version of mask 1045 includes a transparent substrate (e.g., fused quartz) and an opaque material (e.g., chromium) coated in the opaque regions of the binary mask. In another example, mask 1045 is formed using a phase shift technology. In a phase shift mask (PSM) version of mask 1045, various features in the pattern formed on the phase shift mask are configured to have proper phase difference to enhance the resolution and imaging quality. In various examples, the phase shift mask can be attenuated PSM or alternating PSM. The mask(s) generated by mask fabrication 1044 is used in a variety of processes. For example, such a mask(s) is used in an ion implantation process to form various doped regions in semiconductor wafer 1053, in an etching process to form various etching regions in semiconductor wafer 1053, and/or in other suitable processes.

IC fab 1050 is an IC fabrication business that includes one or more manufacturing facilities for the fabrication of a variety of different IC products. In some embodiments, IC Fab 1050 is a semiconductor foundry. For example, there may be a manufacturing facility for the front end fabrication of a plurality of IC products (front-end-of-line (FEOL) fabrication), while a second manufacturing facility may provide the back end fabrication for the interconnection and packaging of the IC products (back-end-of-line (BEOL) fabrication), and a third manufacturing facility may provide other services for the foundry business.

IC fab 1050 includes fabrication tools 1052 configured to execute various manufacturing operations on semiconductor wafer 1053 such that IC device 1060 is fabricated in accordance with the mask(s), e.g., mask 1045. In various embodiments, fabrication tools 1052 include one or more of a wafer stepper, an ion implanter, a photoresist coater, a process chamber, e.g., a CVD chamber or LPCVD furnace, a CMP system, a plasma etch system, a wafer cleaning system, or other manufacturing equipment capable of performing one or more suitable manufacturing processes as discussed herein.

IC fab 1050 uses mask(s) 1045 fabricated by mask house 1030 to fabricate IC device 1060. Thus, IC fab 1050 at least indirectly uses IC design layout diagram 1022 to fabricate IC device 1060. In some embodiments, semiconductor wafer 1053 is fabricated by IC fab 1050 using mask(s) 1045 to form IC device 1060. In some embodiments, the IC fabrication includes performing one or more lithographic exposures based at least indirectly on IC design layout diagram 1022. Semiconductor wafer 1053 includes a silicon substrate or other proper substrate having material layers formed thereon. Semiconductor wafer 1053 further includes one or more of various doped regions, dielectric features, multilevel interconnects, and the like (formed at subsequent manufacturing steps).

In some embodiments, a method of manufacturing an IC includes generating an IC layout diagram, wherein generating the IC layout diagram includes communicating a procedure call from an EDA program to an API, in response to the procedure call, executing a corresponding API procedure, thereby transferring IC layout design criteria to the EDA program, based on the transferred IC layout design criteria, modifying, using the EDA program, the IC layout diagram, and storing, using the EDA program, the modified IC layout diagram in a storage device.

In some embodiments, a non-transitory, computer-readable medium includes instructions executable by processing circuitry of a system to cause the system to perform operations including generating an IC layout diagram, wherein generating the IC layout diagram includes receiving a procedure call from an EDA program at an API, in response to the procedure call, applying, using a corresponding API procedure, IC layout design criteria to the EDA program by at least one of communicating a first portion or all of the IC layout design criteria from the API procedure to the EDA program and causing the EDA program to update information in an IC design database based on the first portion or all of the IC layout design criteria, or updating, using the API procedure, the information in the IC design database based on a second portion or all of the IC layout design criteria, and causing the EDA program to modify the IC layout diagram based on the updated information in the IC design database and store the modified IC layout diagram in a storage device.

In some embodiments, an IC design system includes a processor and a non-transitory, computer readable storage medium including computer program code for one or more programs. The non-transitory, computer readable storage medium and the computer program code are configured to, with the processor, cause the processor to communicate a procedure call from an EDA program to an API, in response to the procedure call, execute a corresponding API procedure, wherein executing the corresponding API procedure includes transferring IC layout design criteria to the EDA program, based on the transferred IC layout design criteria, modify, using the EDA program, the IC layout diagram, and store, using the EDA program, the modified IC layout diagram in a storage device.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of manufacturing an integrated circuit (IC), the method comprising:
generating an IC layout diagram, wherein the generating the IC layout diagram comprises:
communicating a procedure call from an electronic design automation (EDA) program to an application programming interface (API);
in response to the procedure call, executing a corresponding API procedure, thereby transferring IC layout design criteria to the EDA program;
based on the transferred IC layout design criteria, modifying, using the EDA program, the IC layout diagram; and
storing, using the EDA program, the modified IC layout diagram in a storage device.

2. The method of claim 1, wherein the transferring the IC layout design criteria comprises:
communicating the IC layout design criteria from the API procedure to the EDA program; and
updating, using the EDA program, information in an IC design database based on the communicated IC layout design criteria.

3. The method of claim 1, wherein
the transferring the IC layout design criteria comprises updating, using the API procedure, information in an IC design database based on the IC layout design criteria, and
the modifying the IC layout diagram comprises using the updated information in the IC design database.

4. The method of claim 1, wherein
the transferring the IC layout design criteria comprises transferring one or more layout constraints, and
the modifying the IC layout diagram comprises selecting one or more cells based on the one or more layout constraints.

5. The method of claim 1, wherein
the transferring the IC layout design criteria comprises transferring one or more initialization settings to the EDA program, and
the modifying the IC layout diagram comprises performing one or more of a placement procedure, a fill procedure, or a routing procedure using the one or more initialization settings.

6. The method of claim 1, wherein
the transferring the IC layout design criteria comprises transferring one or more cell placement criteria to the EDA program, and
the modifying the IC layout diagram comprises performing a placement procedure using the one or more cell placement criteria.

7. The method of claim 1, wherein
the transferring the IC layout design criteria comprises transferring one or more dummy feature criteria to the EDA program, and
the modifying the IC layout diagram comprises performing a fill procedure using the one or more dummy feature criteria.

8. The method of claim 1, wherein
the transferring the IC layout design criteria comprises transferring one or more routing criteria to the EDA program, and
the modifying the IC layout diagram comprises performing a routing procedure using the one or more routing criteria.

9. The method of claim 1, further comprising:
executing an API verification procedure on the modified IC layout diagram.

10. The method of claim 1, wherein the communicating the procedure call from the EDA program to the API comprises triggering the procedure call in response to one of:
detecting, using the EDA program, an empty region, a predefined structure type, or a predefined placement location in the IC layout diagram, or
starting or finishing an internal procedure of the EDA program.

11. A non-transitory, computer-readable medium including instructions executable by processing circuitry of a system to cause the system to perform operations comprising:
generating an integrated circuit (IC) layout diagram, wherein the generating the IC layout diagram comprises:
receiving a procedure call from an electronic design automation (EDA) program at an application programming interface (API);
in response to the procedure call, applying, using a corresponding API procedure, IC layout design criteria to the EDA program by at least one of:
communicating a first portion or all of the IC layout design criteria from the API procedure to the EDA program and causing the EDA program to update information in an IC design database based on the first portion or all of the IC layout design criteria, or
updating, using the API procedure, the information in the IC design database based on a second portion or all of the IC layout design criteria; and
causing the EDA program to modify the IC layout diagram based on the updated information in the IC design database and store the modified IC layout diagram in a storage device.

12. The non-transitory, computer-readable medium of claim 11, wherein the instructions are executable by the processing circuitry of the system to cause the system to
apply the IC layout design criteria by applying one or more of a performance-based constraint, a layout-dependent effect (LDE) constraint, a parasitic resistance constraint, a parasitic capacitance constraint, or a reliability-based constraint, and
modify the IC layout diagram by selecting one or more cells based on the one or more of the performance-based constraint, the LDE constraint, the parasitic resistance constraint, the parasitic capacitance constraint, or the reliability-based constraint.

13. The non-transitory, computer-readable medium of claim 11, wherein the instructions are executable by the processing circuitry of the system to cause the system to
apply the IC layout design criteria by applying one or more of a row height, a cell orientation, a component description format (CDF) setting, or a cell placement constraint to the EDA program, and
modifying the IC layout diagram by performing a placement procedure using the one or more of the row height, the cell orientation, the CDF setting, or the cell placement constraint.

14. The non-transitory, computer-readable medium of claim 11, wherein the instructions are executable by the processing circuitry of the system to cause the system to
apply the IC layout design criteria by applying one or more of a dummy feature specification, a master dummy cell, a component description format (CDF) setting, or a guard ring feature specification to the EDA program, and
modifying the IC layout diagram by performing a fill procedure using the one or more of the dummy feature specification, the master dummy cell, the CDF setting, or the guard ring feature specification.

15. The non-transitory, computer-readable medium of claim 11, wherein the instructions are executable by the processing circuitry of the system to cause the system to
apply the IC layout design criteria by applying one or more of a routing design rule, routing track information, via size criteria, a parasitic resistance constraint, a parasitic capacitance constraint, or a reliability-based constraint to the EDA program, and
modify the IC layout diagram by performing a routing procedure using the one or more of the routing design rule, the routing track information, the via size criteria, the parasitic resistance constraint, the parasitic capacitance constraint, or the reliability-based constraint.

16. An electronic design automation (EDA) system comprising:
a processor; and
a non-transitory, computer readable storage medium including computer program code for one or more programs, the non-transitory, computer readable storage medium and the computer program code being configured to, with the processor, cause the processor to:
communicate a procedure call from an EDA program to an application programming interface (API);
in response to the procedure call, execute a corresponding API procedure, wherein executing the corresponding API procedure comprises transferring IC layout design criteria to the EDA program;
based on the transferred IC layout design criteria, modify, using the EDA program, the IC layout diagram; and
store, using the EDA program, the modified IC layout diagram in a storage device.

17. The IC design system of claim 16, wherein the non-transitory, computer readable storage medium and the computer program code are configured to, with the processor, cause the processor to:
transfer the IC layout design criteria to the EDA program by at least one of:
communicating the IC layout design criteria from the API procedure to the EDA program and updating, using the EDA program, information in an IC design database based on the communicated IC layout design criteria, or
updating, using the API procedure, the information in the IC design database based on the IC layout design criteria,
wherein the modifying the IC layout diagram comprises modifying the IC layout diagram based on the updated information in the IC design database.

18. The IC design system of claim 16, wherein the non-transitory, computer readable storage medium and the computer program code are configured to, with the processor, cause the processor to:
transfer the IC layout design criteria by transferring one or more layout constraints, and
modify the IC layout diagram by retrieving one or more cells from a cell library based on the one or more layout constraints.

19. The IC design system of claim 16, wherein the non-transitory, computer readable storage medium and the computer program code are configured to, with the processor, further cause the processor to:
perform, using an API verification procedure, a design rule check or a quality check on the modified IC layout diagram.

20. The IC design system of claim 16, wherein the non-transitory, computer readable storage medium and the computer program code are configured to, with the processor, further cause the processor to:
communicate the procedure call from the EDA program to the API by triggering the procedure call in response to one of:
detecting, using the EDA program, an empty region, a predefined structure type, or a predefined placement location in the IC layout diagram, or
starting or finishing an internal procedure of the EDA program.
